(19) United States
(12) Patent Application Publication
(10) Pub. No.: US 2026/0060468 A1
(43) Pub. Date: Mar. 5, 2026

(54) SYSTEM AND PROCESS FOR PREPARING A COLD BREWED BEVERAGE

(71) Applicant: BEAN LAB LLC, Shallotte, NC (US)

(72) Inventors: Derek VIGUERS, Shallotte, NC (US); James VIGUERS, Shallotte, NC (US)

(21) Appl. No.: 19/197,027

(22) Filed: May 2, 2025

Related U.S. Application Data
(60) Provisional application No. 63/688,691, filed on Aug. 29, 2024.

(51) Int. Cl. A47J 31/00; A47J 31/18; A47J 31/44; B65D 85/808

(52) U.S. Cl. CPC A47J 31/005; A47J 31/18; A47J 31/4403; B65D 85/808

(57) ABSTRACT

The subject invention relates to a system for producing and dispensing a liquid extract of coffee or tea that can be brewed in cold or room temperature water and that can be stored fresh in a refrigerator or cooler. The cold brew system comprises a brewing vessel and a double-layer filter bag system designed to reduce spilling and leaks and to improve the smoothness and flavor of the brewed beverage.

### CROSS-REFERENCE TO RELATED APPLICATION

This application claims priority to U.S. Provisional Ser. No. 63/688,691, filed Aug. 29, 2024, which is incorporated herein by reference in its entirety.

### BACKGROUND OF THE INVENTION

Apparatuses for brewing coffee are well known in the art. Coffee is typically drip-brewed using heated water. Water is heated in a vessel, and then poured over a container of ground coffee beans. As the water mingles with the grounds, a coffee extract is produced, which is passed through a filter to create a liquid beverage. Improvements to the art have led to machines that automatically heat water and brew coffee in one self-contained device.

Although coffee is traditionally brewed in hot or boiling water, it is also possible to cold brew coffee. Preference for cold brewed coffee has developed largely due to its flavor profile. Since many of the bitter oils and acids contained in coffee are soluble only at high temperature, coffee brewed with hot or boiling water is characterized by a harsh acrid taste. Thus, cold-brewing coffee effectively avoids this problem. Furthermore, for some coffee drinkers, a coffee beverage prepared and served cold may be preferred over a hot beverage during warmer seasons and in warmer climates.

One method for producing cold brew involves the use of a French press. A French press system works by immersing ground coffee directly in water in a carafe and allowing the loose coffee to steep over a period of several hours. Then, the user slowly lowers a “plunger” device from the top of the carafe to the bottom. The head of the plunger contains a screen that permits the brewed coffee to pass through while forcing the now used coffee grounds to the bottom of the carafe. Once the brewed coffee is separated from the grounds, the user can pour the coffee out of the carafe and into a drinking vessel.

A somewhat similar concept is utilized in infusion pitchers that are designed specifically for cold brew. A screened column containing coffee grounds is submerged in the pitcher filled with water and allowed to steep. Then, the column and spent grounds are removed from the pitcher and the brewed coffee remains.

While these methods are useful and effective, the use of loose coffee grounds can be inconvenient and messy during set up and cleaning of the apparatuses. Furthermore, given that users must control the amount of coffee utilized, the taste and drinkability of the coffee can be inconsistent and lacking.

Certain “disposable” brewing apparatuses that are meant to be discarded after use have been developed by companies such as Grady's Cold Brew® wherein sachets of coffee are steeped in “brew bags” that dispense coffee directly therefrom. Nonetheless, existing brew bag systems possess shortcomings. For example, they require the use of multiple coffee sachets to produce the appropriate strength of cold brew coffee and are often designed to produce a coffee concentrate requiring dilution. Thus, these systems still compromise on taste and smoothness of coffee as a result. Furthermore, the systems utilize components that are not leak-proof and are not designed to reduce spills during setup and dispensing.

Therefore, it is an object of the present invention to provide an improved system that can brew, store and dispense cold-brew coffee and/or tea beverages.

### BRIEF SUMMARY OF THE INVENTION

The subject invention relates to an improved system to produce and dispense a liquid extract of coffee or tea that can be brewed in cold or room temperature water and that can be stored fresh in a refrigerator or cooler for up to, for example, two weeks. The system improves the art of cold brewing and serving beverages, such as cold brewed coffee and cold brewed iced tea.

The cold brew system of the subject invention comprises a brewing vessel comprising an opening for receiving a liquid and having a closure mechanism for sealing the opening. In certain embodiments, the closure is a press-to-close or a slider closure. In preferred embodiments, the brew bag is a stand-up pouch (or “brew bag”) comprising a flat base such that the pouch can be free standing on a surface, such as a shelf or table.

The brewing vessel preferably comprises a means for dispensing liquid therefrom, which communicates with the interior of the vessel. Preferably, the dispensing means is a spout or spigot. In certain preferred embodiments, the spout is a tap spout comprising a removable cap to cover the spout opening. Advantageously, the removable cap prevents liquid from dripping or leaking from the vessel when storing and/or transporting the system.

The system further comprises a means for supplying the ground coffee or tea into the brewing vessel. Preferably, the means for supplying the ground coffee or tea is a bag or sachet housing the coffee or tea. In certain embodiments, the bag or sachet is a filter bag comprised of a double-layer non-woven material. Advantageously, compared with a single-layer filter, the use of the double-layer filter bag enhances the flavor and smoothness of the brewed beverage by, for example, preventing the leaching of fine ground particles out of the bag and into the liquid.

In certain embodiments, the double-layer filter bag also comprises a string attached at one end. The string allows for lifting and lowering the filter bag into and out of the brewing vessel without requiring an additional utensil.

Advantageously, the system of the subject invention requires only one double-layer filter bag comprising the coffee or tea to make over 80 fluid ounces of a cold brew beverage. Furthermore, the beverage can be consumed as prepared, as opposed to being brewed as a concentrate that requires further dilution.

The subject invention further provides a method for brewing a beverage utilizing a system described herein. In one embodiment, the method comprises opening the brewing vessel at the opening; placing the double-layer filter bag inside the brewing vessel; pouring water into the brewing vessel to submerge the double-layer filter bag; sealing the closure mechanism; and placing the filled system into a refrigerator or cooler to steep for, typically, at least 12 hours to produce a cold-brewed beverage.

After the desired level of steeping is complete, the method comprises opening the brewing vessel via the closure mechanism; removing the filter bag from the brewing vessel; and disposing of the filter bag. The brewing vessel can then be resealed using the closure mechanism and the beverage can be decanted from the brewing vessel into a drinking vessel using the dispensing means. The beverage can be consumed as brewed, without requiring dilution. The beverage can also be heated and consumed as a hot beverage.

Advantageously, the system can be sold and used as a convenient “all-in-one” package or kit comprising all necessary components for brewing beverages, with the exception of water. Thus, the system is ideal for use at home and/or can be used when traveling or camping in locations that have access to drinking water.

### BRIEF DESCRIPTION OF THE FIGURES

FIG. 1 is a drawing depicting a cold brew system according to an embodiment of the subject invention.

FIG. 2 is an image of a stand-up pouch, or “brew bag,” brewing vessel according to an embodiment of the subject invention.

FIG. 3 is an image of a tap spout and removable spout cap according to an embodiment of the subject invention.

FIG. 4 is an image of an unwrapped double-layer filter bag being placed into a brew bag according to an embodiment of the subject invention.

FIG. 5 is an image of a double layer filter bag loaded with coffee grounds and a brew bag according to an embodiment of the subject invention.

FIG. 6 is an image of a disassembled brewing system kit according to an embodiment of the subject invention. A double-layer filter bag loaded with coffee grounds is wrapped in vacuum-sealed packaging.

FIG. 7 is an image of an all-in-one cold brew kit according to an embodiment of the subject invention, wherein a vacuum-sealed double-layer filter bag is delivered to a user inside the brew bag.

### FIGURES—REFERENCE NUMBERS

1 . . . cold brew system
2 . . . brewing vessel
3 . . . means for supplying coffee or tea
4 . . . brewing vessel opening
5 . . . brewing vessel closure mechanism
6 . . . base of brewing vessel
7 . . . stand-up brewing vessel (“brew bag”) configuration
8 . . . double press-to-close closure mechanism
9 . . . dispensing means
10 . . . tap spout
11 . . . removable spout cap
12 . . . double-layer filter bag
13 . . . filter bag string
14 . . . filter bag packaging
15 . . . fill line

### DETAILED DESCRIPTION OF THE INVENTION

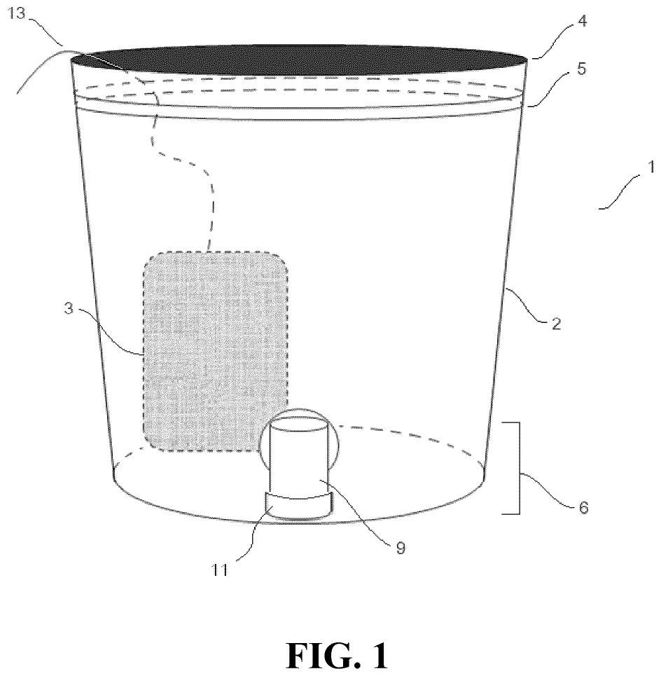

Referring to FIGS. 1-7, the cold brew system of the subject invention 1 is a convenient one-bag system, which comprises a brewing vessel 2 and a means for supplying ground coffee or tea 3 into the brewing vessel 2.

The brewing vessel 2 comprises an opening 4 for receiving a liquid. The brewing vessel can also comprise a closure mechanism 5 for sealing the opening 4. Preferably, the brewing vessel has a flat base 6 so that the brewing vessel 2 can be free standing on a surface, such as a shelf or table.

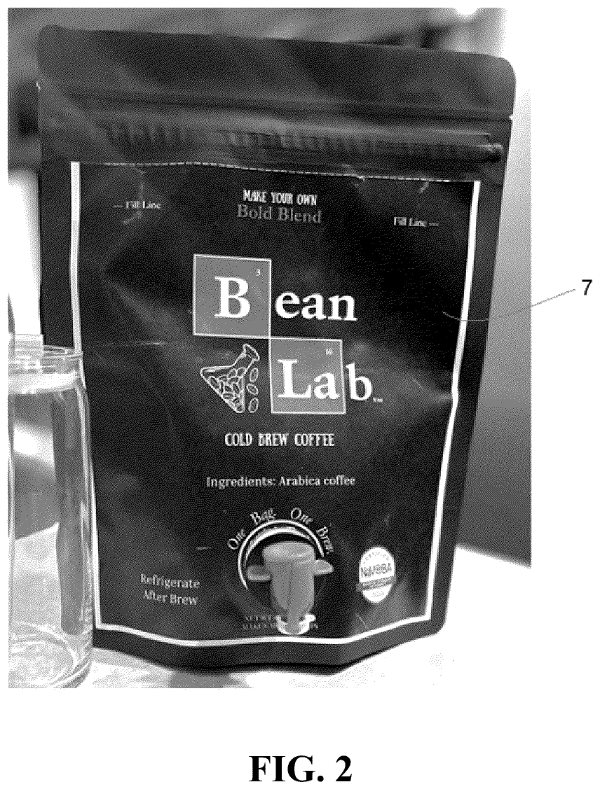

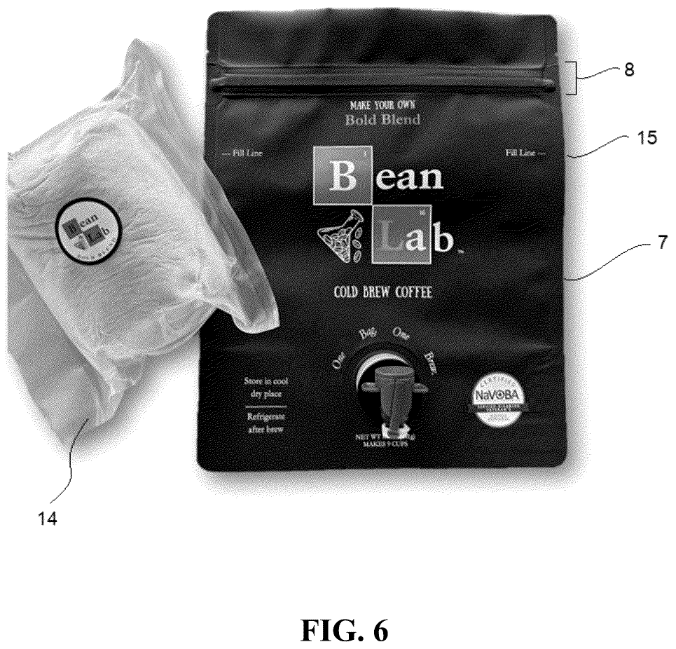

An example of a brewing vessel according to the subject invention is a stand-up pouch (or “brew bag”) 7 (FIG. 2) with the opening 4 located at the top of the pouch and comprising a flat base 6. The closure mechanism 5 of the brew bag 7 can be a press-to-close or a slider closure mechanism. In a preferred embodiment, the closure mechanism 5 is a double press-to-close closure mechanism 8 comprising two parallel zipper tracks that are pulled apart by hand to open and pressed together to seal. FIG. 6. The use of a double press-to-close closure mechanism helps keep the beverage fresh during brewing and storage, in addition to preventing spillage in the even the system is knocked on its side.

In certain embodiments, the brewing vessel is a stand-up pouch 7 manufactured from a flexible, water proof and airtight material, such as, for example, one or more of: plastic, foil, polyethene (PE), polypropylene, aluminum, nylon, polyethene terephthalate (PETE), polyhydroxyalkanoates (PHA), polyvinyl alcohol (PVA), polylactide (PLA), polyglycolide (PGA), polye-caprolactone (PCL). Preferably, the material is free from bisphenols such as bisphenol A (BPA).

In an exemplary embodiment, the brewing vessel 2, e.g., the stand-up pouch 7, comprises a combination of PET, aluminum, nylon and polyethene.

The walls of the brewing vessel 2, e.g., the stand-up pouch 7, can have a thickness of, for example, 50 to 500 microns, 80 to 400 microns, 100 to 300 microns, 150 to 200 microns, or about 180 microns.

In preferred embodiments, the brewing vessel 2, e.g., the stand-up pouch 7, can have a height ranging from about 5 to about 75 inches, or about 8 to about 50 inches, or about 10 to about 25 inches;
a width ranging from about 5 to about 75 inches, or about 8 to about 50 inches, about 10 to about 25 inches, or about 9 to about 15 inches;
a depth ranging from about 0.1 to about 50 inches, or about 3 to about 25 inches, about 5 to about 15 inches, or about 6 to about 8 inches; and
a volume capacity of about 2 to 500 fl. oz., about 6 to 300 fl. oz., about 8 to 240 fl. oz., about 12 to 180 fl. oz., about 18 to 160 fl. oz., about 24 to 140 fl. oz. about 32 to 100 fl. oz., about 36 to 96 fl. oz., about 44 to about 72 fl. oz., or at least 80, 81, 82, 83, 84, 85, 86, 87, 88, 89, 90, 91, 92, 93, 94, 95, 96, 97, 98, or 99 fl. oz.

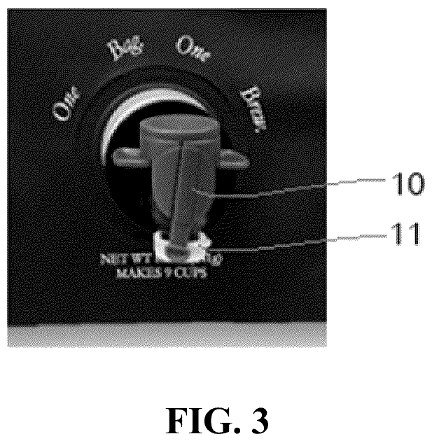

The cold brew system 1 further comprises a means for dispensing liquid 9 from the brewing vessel 2, which communicates with the interior of the brewing vessel 2. Preferably, the dispensing means 9 is a spout or spigot. In certain preferred embodiments, the dispensing means 9 is a tap spout 10 comprising a removable cap 11 to cover the spout opening. FIG. 3. The removable cap 11 is removed from the spout when dispensing liquid through the spout. Advantageously, when in place, the removable cap 11 prevents liquid from dripping or leaking from the brewing vessel 2 when storing and/or transporting the system 1.

The system 1 further comprises one or more means for supplying the ground coffee or tea 3 into the brewing vessel 2. In certain embodiments, the means for supplying the ground coffee or tea 3 contains about 1 oz. to 5 lb. of ground coffee or ground tea leaves, or about 2 oz. to about 2.5 lb., or about 3 oz. to about 1 lb., or about 4 oz. to about 50 oz., or about 5 oz. to about 25 oz., or about 6 oz. to about 10 oz., or about 7 oz. to about 9 oz., or about 8 oz.

The ground coffee or tea typically has a particle size of about 0.1 to 2000 μm, or about 1 to about 1800 μm, or about 10 to about 1600 μm, or about 100 to about 1400 μm, or about 200 to about 1200 μm, or about 300 to about 1000 μm, or about 400 to about 800 μm, or about 500 to about 700 μm, or about 600 μm. In certain embodiments, the coffee or tea has a particle size greater than 1000 μm, i.e., a “coarse” grind.

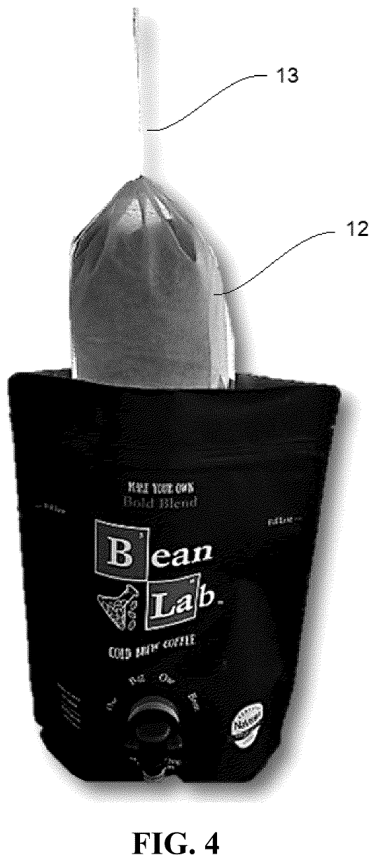

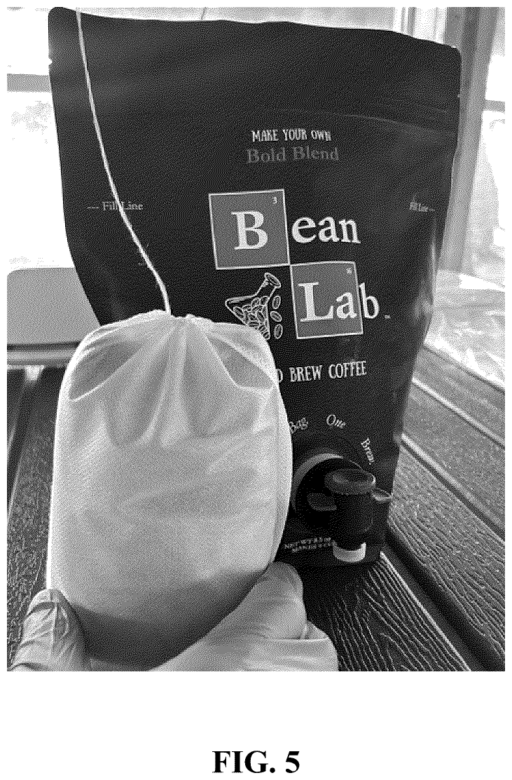

Preferably, the one or more means for supplying the ground coffee or tea 3 is a bag or sachet housing the coffee or tea. In certain embodiments, the bag or sachet is a double-layer filter bag 12 manufactured from food-safe natural or synthetic materials, including but not limited to, cotton, hemp, polyester, steel, aluminum, polypropylene, nylon and fluoropolymers. Preferably, the material is a non-woven material. FIGS. 4-5. Advantageously, compared with a single-layer filter bag, the use of the double-layer filter bag 12 enhances the flavor and smoothness of the brewed beverage by, for example, reducing the leaching of fine ground particles out of the bag and into the liquid. In certain embodiments, the subject invention comprises from 1 to 3 means for supplying the ground coffee or tea 3.

In certain embodiments, the double-layer filter bag 12 comprises two single-layer filter bags, wherein a first single-layer filter bag contains the ground coffee or tea and the second single-layer filter bag contains the first single-layer filter bag.

The double-layer filter bag 12 can have a length and/or a width ranging from, for example, 3 to 12 inches, 4 to 10 inches, 5 to 8 inches, or 6 to 7 inches. In an exemplary embodiment, the filter bag has a length of about 8 inches and width of about 6 inches.

In certain embodiments, the double-layer filter bag 12 also comprises a string 13 attached at one end. The string may function as a drawstring to close the double-layer filter bag after ground coffee or tea are loaded therein. Advantageously, the string 13 allows for lifting and lowering the filter bag 12 into and out of the brewing vessel 2 without requiring an additional utensil. Preferably, the string 13 is about 2 to 12 inches, or about 3 to 10 inches, or about 4 to 9 inches, or about 5 to 8 inches, or about 6 to 7 inches in length.

In some embodiments, the filter bag 12 is supplied to the user in vacuum-sealed packaging 14 in order to preserve the ground coffee or tea without the use of preservatives. FIG. 6.

Advantageously, in certain embodiments, the system 1 of the subject invention requires only one filled double-layer filter bag 12 comprising the coffee or tea to make over 80 fluid ounces of a cold brew beverage. Furthermore, the beverage can be consumed as prepared, as opposed to being brewed as a concentrate that requires further dilution. In certain embodiments, however, the system can utilize more than one filled double-layer filter bag 12 if, for example, a larger brewing vessel is used and/or a concentrated cold-brew beverage is desired.

### Brewing Method

The subject invention further provides a method for brewing a beverage utilizing a system 1 described herein. In one embodiment, the method comprises opening the brewing vessel 2 at the opening 4; placing the one or more means for supplying the coffee or tea grounds 3 inside the brewing vessel 2; pouring water into the brewing vessel 2 to submerge the one or more means for supplying the coffee or tea grounds 3; sealing the closure mechanism 5; and placing the filled system 1 into a refrigerator or cooler for at least 12 hours to produce a cold-brewed beverage.

After the desired level of steeping is complete, the method comprises opening the closure mechanism 5 of the brewing vessel 2; removing the one or more means for supplying the coffee or tea grounds 3 from the brewing vessel 2; and resealing the brewing vessel 2 containing the brewed beverage using the closure mechanism 5. The beverage can be decanted into a drinking vessel using the dispensing means 9.

### Brew Bag Configuration

In an exemplary embodiment, the brewing vessel 2 is a stand-up pouch configuration 7 (“brew bag”) and the means for supplying the coffee or tea grounds 3 is a double-layer filter bag 12 comprising a string 13. Upon placing the double-layer filter bag 12 into the brew bag 7, the string 13 can be secured at the opening 4 of the brew bag 7 by closing a portion of the closure mechanism 5 over the string 4, thus keeping a portion of the string dry. See FIG. 1. Advantageously, this allows for a user to remove the filter bag 12 by hand with reduced mess.

In certain embodiments, if a concentrated cold-brew beverage is desired, more than one double-layer filter bag 12 can be added to the brew bag 7 in a single brewing cycle.

Water having a temperature at about room temperature or colder, e.g., between about 0° C. to about 20° C., is poured into the brew bag 7 to a desired volume, e.g., approximately 70-90 fl. oz., so that the one or more double-layer filter bags 12 are submerged in the water. In some embodiments, the brew bag 6 is marked with a fill line 15 to assist in measuring the amount of water.

The brew bag 6 comprising a double press-to-close closure mechanism 8 is sealed completely and the system 1 is placed in a refrigerator or a cooler at greater than 0° C. but less than about 5° C., preferably between 4.0° C. and 4.5° C., throughout the brewing cycling. The double-layer filter bag 12 is then allowed to steep for, typically, 12 hours, 18 hours, or 24 hours, or some amount of time therebetween.

After the desired level of steeping is complete, the method comprises opening the double press-to-close closure mechanism 8; and grasping the string 13 of the double-layer filter bag 12 to remove the filter bag 12 from the liquid. The brew bag 7 can then be resealed using the double press-to-close closure mechanism 8. The filter bag 12 can be disposed of.

The resulting cold brew beverage can be decanted into a drinking vessel using the dispensing means, e.g., the tap spout 10, after removing the spout cap 11. The beverage can be consumed as brewed, without requiring dilution. The beverage can also be heated and consumed as a hot beverage.

The brew bag, containing the cold-brew beverage, can be stored in a refrigerator or a cooler at greater than 0° C. but less than about 5° C., preferably between 4.0° C. and 4.5° C., for up to two weeks (14 days). Once the beverage has been completely dispensed, the entire apparatus can, in some embodiments, be disposed of or recycled.

Coffee brewed in the system 1 is a smooth, flavorful, unconcentrated beverage that is less acidic than conventionally brewed coffee.

### ***

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,”“and”and “the”are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

While specific apparatus has been disclosed in the preceding description, it should be understood that these specifics have been given for the purpose of disclosing the principles of the present invention and that many variations thereof will become apparent to those who are versed in the art. Therefore, the scope of the present invention is to be determined by the appended claims.

Any element in a claim that does not explicitly state “means for” performing a specified function performing a specific function, is not to be interpreted as a “means” clause as specified in 35 U.S.C. § 112, paragraph 6.

### EXAMPLES

It should be understood that the examples and embodiments described herein are for illustrative purposes only and that various modifications or changes in light thereof will be suggested to persons skilled in the art and are to be included within the spirit and purview of this application.

### Example 1—All-In-One Cold-Brew Kit and Use Thereof

A system according to the subject invention can be sold and used as a convenient “all-in-one” package or kit comprising all necessary components for brewing beverages, with the exception of water. Thus, the system is ideal for use at home and/or can be used when traveling or camping in locations that have access to drinking water.

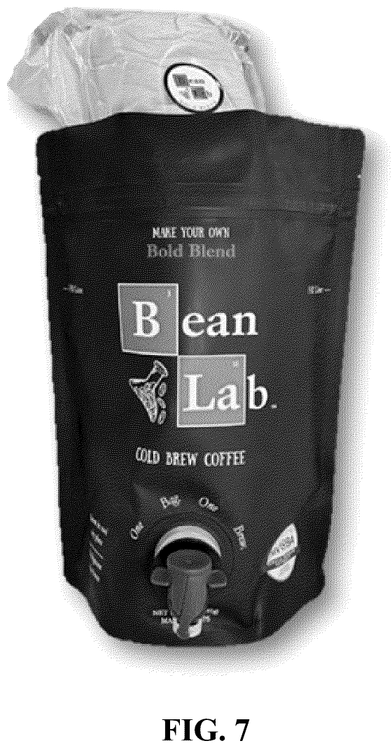

As depicted in FIGS. 6-7, the all-in-one brew kit can comprise a stand-up brew bag measuring 12.5 inches (H)×9.5 inches (W)×6 inches (D) and has a capacity of at least 72 fluid ounces. In other embodiments, the stand-up brew bag measures 17-18 inches (H)×10.5 inches (W)×7 inches deep.

The wall thickness of the brew bag is 180 μm. The brew bag is manufactured from PET, aluminum, nylon and PE.

The brew bag comprises a plastic tap spout affixed with a removable spout cap over the opening of the spout.

The brew bag 7 is delivered vacuum-sealed with a vacuum-sealed filter bag inside. The filter bag comprises a string and contains approximately 8.0 to 8.5 oz. of pre-measured, preservative-free coffee and/or tea grounds. The bag itself is comprised of non-woven synthetic materials and measures approximately 6 in×8 in when unfilled.

Upon receipt of the kit, the user opens the brew bag to remove and unwrap the loaded filter bag. After unwrapping the filter bag and placing it into the brew bag, the user secures the filter bag string into the corner of the press-to-close closure mechanism at the opening of the brew bag. The user then supplies water from an external drinking water source into the brew bag to the fill line marked on the outside of the brew bag, equaling approximately 84 fluid ounces, and seals the opening of the brew bag using the closure mechanism. The water should be between 0° C. and 20° C.

The submerged filter bag steeps for 12 to 24 hours, after which the brew bag is opened and the filter bag is removed and discarded. The system is intended for single-use application; however, the system could be reused by obtaining additional filter bags.

The user can then remove the spout cap on the tap spout and use the tap spout to dispense the brewed beverage into a glass or other drinking vessel to consume without dilution. In some instances, the kit includes a drinking vessel, such as a glass, mug, or bottle.

The system comprising the brewed beverage is stored, sealed, at a temperature of 0° C. to 5° C. for up to about two weeks (14 days).

I claim:

1. A system for producing a brewed beverage, the system comprising:
a) a brewing vessel; and
b) one or more means for supplying ground coffee or tea into the brewing vessel;
wherein the brewing vessel comprises an opening for receiving a liquid and a closure mechanism for sealing the opening; a flat base; and a means for dispensing liquid from the interior of the brewing vessel; and
wherein the one or more means for supplying ground coffee or tea into the brewing vessel comprise one or more double-layer filter bags with the ground coffee or tea contained therein.

2. The system of claim 1, wherein the brewing vessel is a stand-up pouch.

3. The system of claim 1, wherein the dispensing means is a tap spout.

4. The system of claim 3, wherein the tap spout comprises an opening, and wherein the opening is covered with a removable cap.

5. The system of claim 1, wherein the closure mechanism is a single or double press-to-close closure mechanism.

6. The system of claim 1, wherein the brewing vessel is manufactured from one or more of: plastic, foil, polyethene (PE), polypropylene, aluminum, nylon, polyethene terephthalate (PETE), polyhydroxyalkanoates (PHA), polyvinyl alcohol (PVA), polylactide (PLA), polyglycolide (PGA), and polye-caprolactone (PCL).

7. The system of claim 1, wherein the brewing vessel is a stand-up pouch comprised of a combination of PET, aluminum, nylon and polyethene.

8. The system of claim 1, wherein the brewing vessel is a stand-up pouch with walls having a thickness of about 150 to 200 microns.

9. The system of claim 1, wherein the brewing vessel is a stand-up pouch having a volume capacity of about 32 to 100 fluid ounces.

10. The system of claim 1, wherein each double-layer filter bag contains about 2 oz. to about 10 oz. of ground coffee or tea.

11. The system of claim 1, wherein the ground coffee or tea has a particle size of greater than 1,000 μm.

12. The system of claim 1, wherein the double-layer filter bag is manufactured from food-safe natural or synthetic materials selected from one or more of cotton, hemp, polyester, steel, aluminum, polypropylene, nylon and fluoropolymers.

13. The system of claim 1, wherein the double-layer filter bag comprises a string attached at one end.

14. A method for brewing a cold-brew beverage utilizing a system of claim 1, the method comprising:
opening the brewing vessel at the opening;
placing the one or more means for supplying the coffee or tea grounds inside the brewing vessel;
pouring an amount of water into the brewing vessel to submerge the one or more means for supplying the coffee or tea grounds;
sealing the closure mechanism;
storing the filled brewing vessel in a refrigerator or cooler for at least 12 hours to allow the coffee or tea to steep into the water to produce the cold-brewed beverage;
opening the closure mechanism;
removing the one or more means for supplying the coffee or tea grounds from the brewing vessel;
resealing the brewing vessel containing the brewed beverage using the closure mechanism.

15. The method of claim 14, further comprising dispensing the brewed beverage from the brewing vessel using the dispensing means.

16. The method of claim 14, wherein the means for supplying the coffee or tea grounds is a double-layer filter bag comprising a string attached to one end, and wherein the method comprises securing an end of the string at the opening of the brewing vessel by closing a portion of the closure mechanism over the string.

17. The method of claim 14, wherein the water has a temperature between of about 20° C. or colder.

18. The method of claim 14, wherein the amount of water is approximately 70-100 fl. oz.

19. The method of claim 14, wherein the filled brewing vessel is stored in a refrigerator or a cooler at a temperature greater than 0° C. but less than about 5° C.

20. The method of claim 14, further comprising storing the resealed brewing vessel containing the brewed beverage at greater than 0° C. but less than about 5° C. for up to two weeks (14 days).
